(19) United States
(12) Patent Application Publication
(10) Pub. No.: US 2019/0226295 A1
(43) Pub. Date: Jul. 25, 2019

(54) ELASTOMER CHARACTERIZATION

(71) Applicant: Cameron International Corporation, Houston, TX (US)

(72) Inventors: Ray Zonoz, Sugarland, TX (US); Xuming Chen, Katy, TX (US)

(73) Assignee: Cameron International Corporation, Houston, TX (US)

(21) Appl. No.: 15/879,810

(22) Filed: Jan. 25, 2018

(51) Int. Cl. E21B 33/035; E21B 47/12; C09K 8/42; E21B 33/038

(52) U.S. Cl. CPC E21B 33/0355; E21B 33/038; C09K 8/422; E21B 47/123

(57) ABSTRACT

Service life characteristics of an elastomer component used for sealing in a BOP are monitored. Measurements are made in situ on the BOP while deployed at a wellsite. The measurements can be related to contact pressure and/or sealing pressure of elastomer components in an annular BOP. The measurements are used to monitor the service life of the elastomer component.

### TECHNICAL FIELD

The present disclosure relates to systems and methods for elastomer characterization. More specifically, the present disclosure relates to systems and methods that use stress and/or pressure measurements to characterize elastomeric components used in blowout preventers.

### BACKGROUND

Elastomeric materials are used for a variety of applications in many different settings. In the oil and gas industry, elastomer material is used in many components including seals, donuts, and packers. In many situations such as in the oil and gas industry, in situ monitoring the elastomer properties, such as for fatigue due to temperature and/or pressure cycling, is either impossible or impractical due to the inaccessibility of the component and/or a relatively high intervention cost.

In well drilling operations such as in the oil and gas industry, blowout preventers (BOPS) are an important safety “valve” for well pressure control. In annular BOPs, each of the elastomer packer elements of each BOP has its operational lifetime or service life. The service life of the packer element is influenced by the operation conditions such as closing/opening cycles, pressures, temperatures, exposed chemicals etc. The service life can be significantly reduced due to the adverse operation conditions such as high operation pressures, temperatures and harsh chemicals. This situation causes significant challenges in predicting the service life of packer element of BOPs. In a real well blowout situation, a mis-prediction on service life of packer element of BOP could have severe consequences. Therefore, a reasonable prediction of the service life of packer element of BOP could not only reduce the operation cost, but also increase the safety confidence level during operation. In subsea BOPs, the prediction of service life of packer element becomes even more important because it is extremely expensive to replace the packer element in subsea installation. Furthermore, the subsea environment requires an even higher safety confidence level for BOPs during operation. Hence, a reliable method to monitor the service life of elastomeric packer elements in BOPs in the oil and gas wells is highly desirable.

### SUMMARY

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

According to some embodiments, methods are described for monitoring service life characteristics of an elastomer component made of an elastomer material. The elastomer component is used for sealing in a BOP and the methods can include: measuring in situ on the BOP while deployed at a wellsite a parameter indicating sealing pressure of the elastomer component; and estimating a service life characteristic of the elastomer component based at least in part on the in situ measurement of the parameter.

According to some embodiments, the measuring is made with a sensor device that directly contacts elastomer material of the elastomer component being monitored or of a second elastomer component that directly contacts the elastomer component being monitored. According to some embodiments, the measuring is made with a sensor device configured to measure contact pressure of the elastomer material.

According to some embodiments, the sensor device is of one of the following types: an integrated electronic piezoelectric (IEPE) pressure sensor; a strain gage configured to measure deformation of a diaphragm contacting the elastomer material; and a type that employs an optical fiber having a plurality of distributed Bragg reflectors contained therein. In some cases, the optical fiber directly contacts elastomer material of the elastomer component being monitored or of a second elastomer component that directly contacts the elastomer component being monitored. Alternatively or in addition, the optical fiber can directly contact a metallic casing that houses the elastomer component being monitored or a second elastomer component that directly contacts the elastomer component being monitored.

According to some embodiments, the estimates of service life are at least based in part on comparing the in situ measurements with a predetermined value or values that indicate when elastomer component is nearing the end of its useful life. The predetermined value or values can be set based on measurements made under real or simulated conditions, such as in a laboratory setting. The predetermined value or values can be set based on analysis of prior BOP case studies. According to some embodiments, the estimates of service life can be based on detecting changes in stress relaxation behavior of the elastomer material.

The BOP can be an annular type or ram-type BOP, and in some embodiments, the BOP is deployed in a subsea location.

According to some embodiments, methods are also described for investigating causes of failure of one or more components of a BOP. The methods can include: measuring in situ on the BOP while deployed at a wellsite a parameter indicating sealing pressure of an elastomer component used for sealing in the BOP; recording the in situ measurements; and analyzing the recoded measurements to determine one or more parameters related to failure of one or more components of the BOP. According to some embodiments, the one or more parameters can include one or more of the following: number of BOP actuations, number of BOP pressure tests, number of stripping operations preformed using the BOP, and number of j oints passing the BOP during stripping operations.

As used herein the term “sealing pressure” of an elastomeric component refers to the pressure the elastomeric component exerts on a sealing object. As used herein parameters that indicate sealing pressure also include parameters that indicate properties closely related to sealing pressure of the elastomer such as contact pressure and material stress of the elastomer.

### BRIEF DESCRIPTION OF THE DRAWINGS

The subject disclosure is further described in the following detailed description, and the accompanying drawings and schematics of non-limiting embodiments of the subject disclosure. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a diagram illustrating a drilling and/or producing wellsite where an elastomer characterization system could be deployed, according to some embodiments;

FIG. 2 is a cross section of an annular BOP that includes an elastomer characterization system, according to some embodiments;

FIGS. 3 and 4 are diagrams showing results of finite element analysis of pressure within the elastomeric components of an annular BOP during uncompressed and compressed stated, respectively;

FIG. 5 is a plot illustrating changes in contact pressure in the elastomer components of an annular BOP during closing and pressure holding;

FIG. 6 is a plot illustrating contract pressure characteristics changing over time for elastomer components of an annular BOP;

FIG. 7 is a diagram illustrating a strain gauge configured for making contact pressure measurements on the elastomer components of annular BOPs, according to some embodiments; and

FIG. 8 is a diagram illustrating an annular BOP configured with an elastomer characterization system, according to some further embodiments.

### DETAILED DESCRIPTION

The particulars shown herein are for purposes of illustrative discussion of the embodiments of the present disclosure only. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

According to some embodiments, systems and methods are described for monitoring the service life of packer elements for annular BOPs using measurements that indicated stress on the packer element. In some embodiments one or more sensors (such as pressure and/or strain sensors) are installed on the top of BOP housing where the contact pressure of the elastomeric packer element can be directly measured. The measured contact pressure/strain, which indicates stress in the elastomeric packer material, can be correlated with the service life of packer element of annular BOP. Thus, the service life of packer elements can be monitored and/or predicted. According to some embodiments, the described monitoring system is used to monitor the use and operation of the BOP.

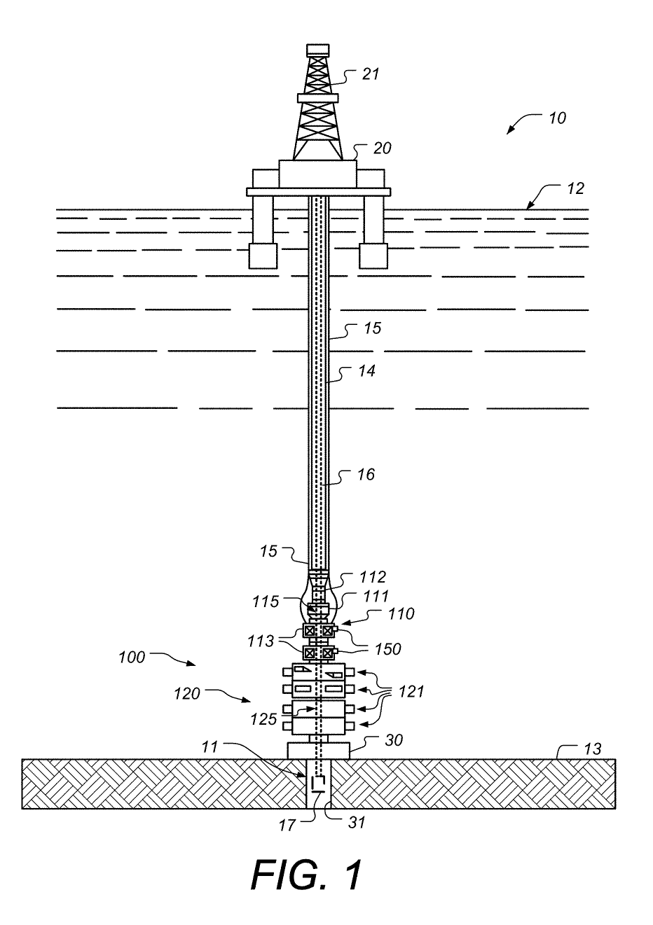

FIG. 1 is a diagram illustrating a drilling and/or producing wellsite where an elastomer characterization system could be deployed, according to some embodiments. In this example, an offshore drilling system is being used to drill a wellbore 11. The system includes an offshore vessel or platform 20 at the sea surface 12 and a subsea blowout preventer (BOP) stack assembly 100 mounted to a wellhead 30 at the sea floor 13. The platform 20 is equipped with a derrick 21 that supports a hoist (not shown). A tubular drilling riser 14 extends from the platform 20 to the BOP stack assembly 100. The riser 14 returns drilling fluid or mud to the platform 20 during drilling operations. One or more hydraulic conduit(s) 15 extend along the outside of the riser 14 from the platform 20 to the BOP stack assembly 100. The conduit(s) 15 supply pressurized hydraulic fluid to the assembly 100. Casing 31 extends from the wellhead 30 into the subterranean wellbore 11.

Downhole operations, such as drilling, are carried out by a tubular string 16 (e.g., drillstring) that is supported by the derrick 21 and extends from the platform 20 through the riser 14, through the BOP stack assembly 100, and into the wellbore 11. In this example, a downhole tool 17 is shown connected to the lower end of the tubular string 16. In general, the downhole tool 17 may comprise any suitable downhole tool(s) for drilling, completing, evaluating, and/or producing the wellbore 11 including, without limitation, drill bits, packers, cementing tools, casing or tubing running tools, testing equipment and/or perforating guns. During downhole operations, the string 16, and hence the tool 17 coupled thereto, may move axially, radially, and/or rotationally relative to the riser 14 and the BOP stack assembly 100.

The BOP stack assembly 100 is mounted to the wellhead 30 and is designed and configured to control and seal the wellbore 11, thereby containing the hydrocarbon fluids (liquids and gases) therein. In this example, the BOP stack assembly 100 comprises a lower marine riser package (LMRP) 110 and a BOP or BOP stack 120. The LMRP 110 includes a riser flex joint 111, a riser adapter 112, annular BOPs 113, and a pair of redundant control units or pods. A flow bore 115 extends through the LMRP 110 from the riser 14 at the upper end of the LMRP 110 to the connection at the lower end of the LMRP 110. The riser adapter 112 extends upward from the flex joint 111 and is coupled to the lower end of the riser 14. The flex joint 111 allows the riser adapter 112 and the riser 14 connected thereto to deflect angularly relative to the LMRP 110, while wellbore fluids flow from the wellbore 11 through the BOP stack assembly 100 into the riser 14. The annular BOPs 113 each include annular elastomeric sealing elements that are mechanically squeezed radially inward to seal on a tubular extending through the LMRP 110 (e.g., the string 16, casing, drillpipe, drill collar, etc.) or seal off the flow bore 115. Thus, the annular BOPs 113 have the ability to seal on a variety of pipe sizes and/or profiles, as well as perform a “Complete Shut-off” (CSO) to seal the flow bore 115 when no tubular is extending therethrough. According to some embodiments, each of the BOPs 113 includes one or more elastomer stress sensors 150 are configured to make stress measurements on the elastomeric sealing elements so that characterizations of their properties can be calculated.

In this embodiment, the BOP stack 120 comprises annular BOPs 113 as previously described, choke/kill valves, and choke/kill lines. A main bore 125 extends through the BOP stack 120. In addition, the BOP stack 120 includes a plurality of axially stacked ram BOPs 121. Each ram BOP 121 includes a pair of opposed rams and a pair of actuators that actuate and drive the matching rams. In this embodiment, the BOP stack 120 includes four ram BOPs 121—an upper ram BOP 121 including opposed blind shear rams or blades for severing the tubular string 16 and sealing off the wellbore 11 from the riser 14; and the three lower ram BOPs 120 including the opposed pipe rams for engaging the string 16 and sealing the annulus around the tubular string 16. In other embodiments, the BOP stack (e.g., the stack 120) may include a different number of rams, different types of rams, one or more annular BOPs, or combinations thereof.

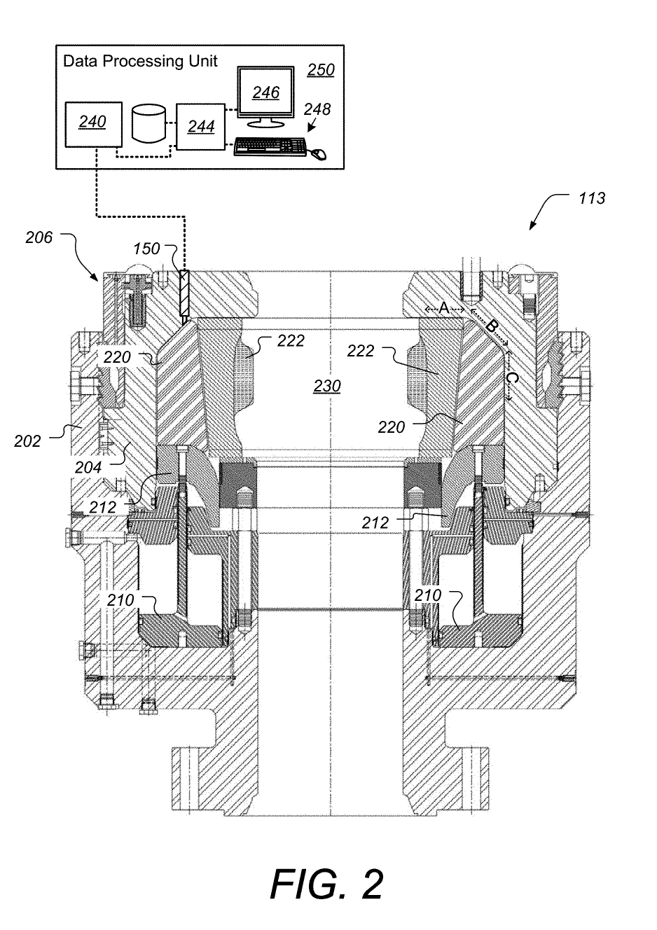

FIG. 2 is a cross section of an annular BOP that includes an elastomer characterization system, according to some embodiments. In this example, the BOP 113 includes two elastomer components: donut 220 and packer 222. In order to close and seal the BOP 113, hydraulic fluid enters below piston 210 and pushes it upwards. The piston 210 lifts pusher plate 212, which in turn pushes on donut 220. The pressure on donut 220 forces the packer 222 radially inwards to form a seal with any tube within the BOP bore 230 (or sealing off the bore 230 if there is no tube or pipe present). To re-open the BOP, the hydraulic fluid enters above the piston 210 thereby forcing it back downwards. In some embodiments, separate pistons can be used for opening and closing the BOP 113. An elastomer stress sensor 150 is installed on the top of the body 206, within casing 204 of BOP 113. The sensor 150 is in contact with the elastomer donut 220. By being in contact with donut 220, the contact pressure of donut 220 can be monitored. As used herein, the term ‘contact pressure’ refers to an average normal stress exerted by the elastomer on the membrane of the sensor 150. According to some embodiments, the monitoring system could be battery powered or power can be supplied from offshore vessel or platform 20 or the BOP stack assembly 100 (both shown in FIG. 1). A data transmission/link can be wired to an acquisition system in data processing unit 250, or make use of wireless transmission technology such as acoustic telemetry (e.g. in subsea) or radio-frequency (e.g. on surface). The storage system 242 can be a part of the surface acquisition system or it could be embedded at the sensor level or at the BOP stack level.

Also shown in FIG. 2 is data processing unit 250, which according to some embodiments, includes a central processing system 244, a storage system 242, communications and input/output modules 240, a user display 246 and a user input system 248. Input/output modules 240 are in data communication with the sensor 150 as shown by the dotted line. The data processing unit 250 may be located in offshore vessel or platform 20 (shown in FIG. 1), or may be located in other facilities near the wellsite or in some remote location. According to some embodiments, processing unit 250 is also used to monitor and control at least some other aspects of drilling operations or other functions on vessel or platform 20 (shown in FIG. 1).

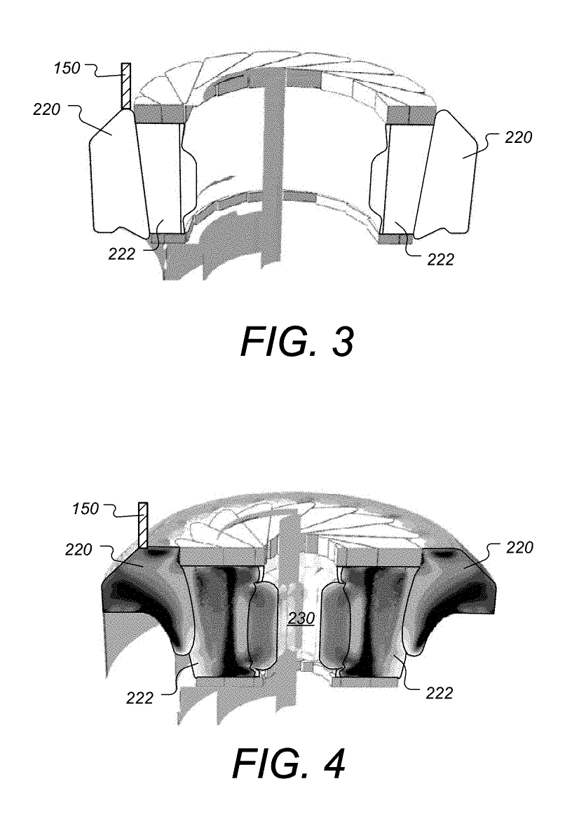

FIGS. 3 and 4 are diagrams showing results of finite element analysis of pressure within the elastomeric components of an annular BOP during uncompressed and compressed stated, respectively. Also shown is the location of the elastomer stress sensor 150 installed on top of elastomer donut 220. The stress sensor 150 monitors the contact pressure changes during compression of the donut 220. FIGS. 3 and 4 shown the results of finite element analysis. As can be seen in FIG. 4, the contact pressure measured by sensor 150 is equal to the contact pressure on the wellbore pipe within bore 230. The equivalence is due to the isotropic uncompressing characteristics of the elastomeric materials. Therefore, if the contact pressure as measured by sensor 150 is not high enough to hold the wellbore pressure, a leakage will be likely to occur. According to some embodiments, the contact pressure measurement from sensor 150 can be used to monitor the BOP packer elements in either closed or opened positions.

Stress relaxation behavior of the elastomer material is a factor that affects the contact pressure, and resulting contact pressure decay. According to some embodiments, the stress relaxation behavior is used as an indicator to monitor the service life of BOP packer elements. Elastomers used for packer elements are typically polymeric elastomers comprising various fillers such as carbon black, clay and silica. See e.g. U.S. Pat. No. 9,616,659, and U.S. patent application Ser. No. 15/218,936, both incorporated herein by reference, which discuss typical compositions of BOP elastomers. Elastomers have strong Payne effects and stress soften effects (Mullin effects) due to the filler polymer interactions. This leads to a strong stress history effect of elastomer during deformation. For instance, the stress relaxation behavior tends to change slightly after each compression cycle.

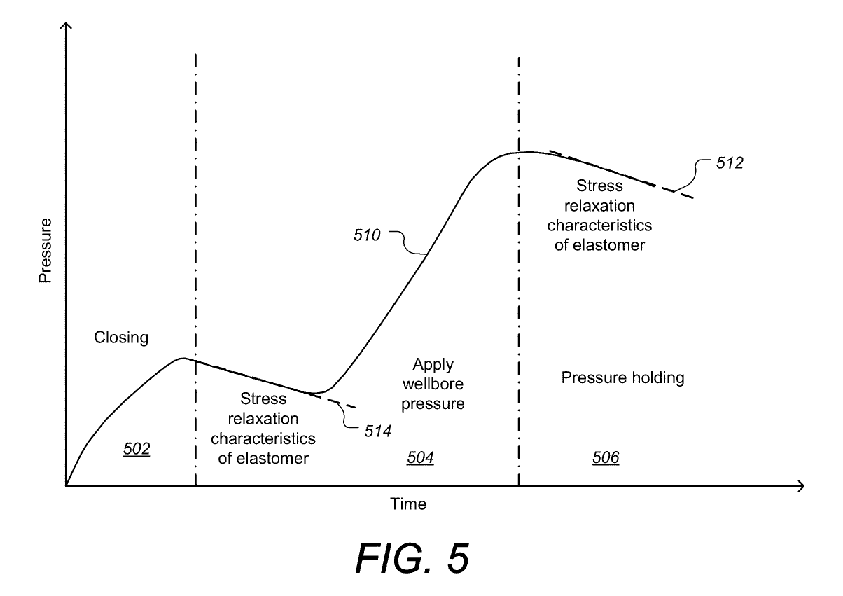

FIG. 5 is a plot illustrating changes in contact pressure in the elastomer components of an annular BOP during closing and pressure holding. The curve 510 shows a typical pressure curve, which could be measured for example using a sensor such as sensor 150 shown in FIG. 2. As shown, there are typically distinct phases including the closing phase 502 which ends when the elastomer packer is fully engaged against the drill pipe. In phase 504, the well bore fluid pressure is applied. In phase 506 the well bore pressure is held by the BOP. Note that the slopes shown in FIG. 5 are for illustrative purposes and do not necessarily reflect the actual time scale. In phase 506, the stress relaxation characteristics of the elastomer are reflected in the slope shown by dashed line 512. Similarly, in phase 504, the stress relaxation characteristics of the elastomer are also reflected in the slope shown by dashed line 514. As discussed above, the stress relaxation characteristics, for example as measured by the slope 512, will typically be different after each compression cycle.

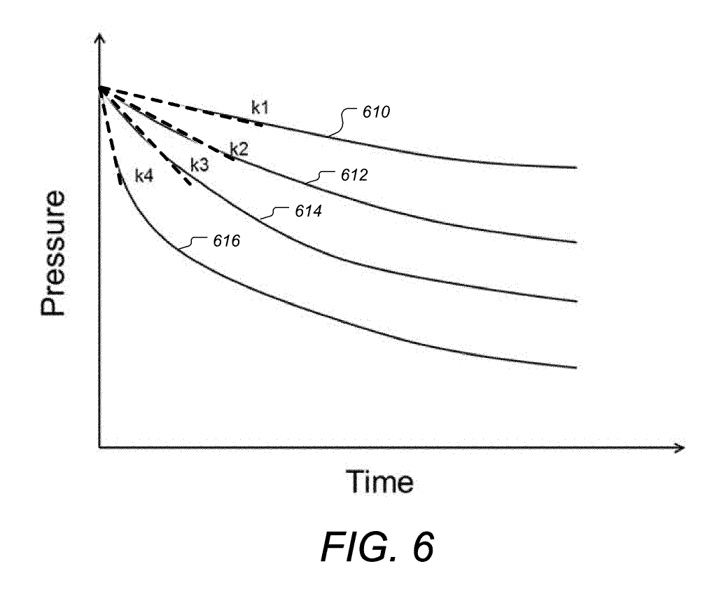

FIG. 6 is a plot illustrating contract pressure characteristics changing over time for elastomer components of an annular BOP. The four curves 610, 612, 614 and 616 represent contact pressure of an elastomer component of an annular BOP, such as sensor 150 shown in FIG. 2. The measurements are made during a “pressure holding” phase such as phase 506 shown in FIG. 5. The slopes of each curve are shown by the dashed lines k1, k2, k3 and k4. The stress relaxation characteristic, and therefore the slopes k1, k2, k3 and k4 are effected by various factors over time, such as the number of closing/opening cycles as well as exposure to pressures, temperatures, chemicals. In general it has been found that, over time, the stress relaxation slope becomes steeper. According to some embodiments, the unique stress relaxation characteristics as measured by the contact pressure by a sensor is used to predict the state of the BOP elastomer elements. By monitoring the stress relaxation behavior of the contact pressure, the service life of the BOP packer elements can be monitored.

In addition to stress relaxation, other factors that can affect the contact pressure include chemical attack (such as mud other wellborn fluids), thermal degradations, and high pressure extrusions. According to some embodiments, two or more of those factors (including stress relaxation) are combined together to provide an even stronger impact on the changes of contact pressure, thereby further improving monitoring of the elastomer material, under some circumstances.

According to some embodiments, measurements of contract pressure on the elastomer material during other BOP phases, such as during the closing phase (e.g. phase 502 in FIG. 5) and/or the pressurization phase (e.g. phase 504 in FIG. 5) can be used to learn information regarding BOP packer health. For example, the contact pressure can be measured vs. piston closing position during the closing step. For the pressurization phase, the contact pressure could be measured vs. well pressure. For further details on measuring piston position, see e.g. U.S. Pat. App. Publ. 2015/0007651 and U.S. Pat. App. Publ. 2016/0123785, both of which are incorporated by reference herein.

According to some embodiments, data collection on multiple cases is used combined with analysis to set initial criteria on service life. The criteria can be further refined using algorithms/data science and statistics. The data analysis could be based on actual physics-based parameters and/or from multiple parameters with statistical behavior considered as inputs for machine learning algorithm(s).

According to some embodiments, the sensor 150 (e.g. shown in FIG. 2) can be selected from various suitable types of devices. For example, sensor 150 can be a piezoelectric type sensors such as an integrated electronic piezoelectric (IEPE) pressure sensor. One suitable type of IEPE is a Type 211B IEPE, which is a general purpose pressure sensors that measure transient and repetitive dynamic events in a wide variety of applications. Type 211B IEPE sensors typically have low impedance, voltage mode, high level voltage signal, high natural frequency and are acceleration compensated. They are well suited for fast transient measurement under varied environmental conditions.

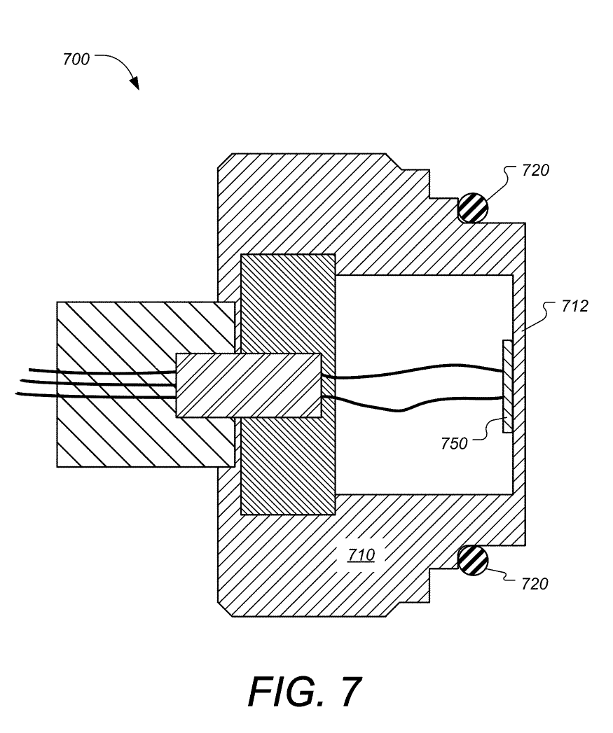

Other types of sensors can be used to make contact pressure measurements on the elastomer components of annular BOPs. FIG. 7 is a diagram illustrating a strain gauge configured for making contact pressure measurements on the elastomer components of annular BOPs, according to some embodiments. Sensor 700 can be used to make contract pressure measurements, and can be substituted with or used in addition to sensor 150 shown and described elsewhere herein. Sensor 700 has a body 710 that includes a metallic membrane 712. The sensor 700 can be mounted within an annular BOP such that the outer surface of membrane 712 is in direct contact with an elastomer component of the BOP, such as shown and described with respect to sensor 150. Sealing means such as O-ring 720 can be used for the mounting. Strain gauge 750 is mounted to the inner surface of membrane 712 as shown. When the membrane 712 is deformed due to contact pressure from the elastomer component, the strain gauge 750 is also deformed. The deformation of the strain gauge 750 can be measured (e.g. by altering an electrical resistance) and recorded using known techniques. Although piezoelectric type sensors and strain gauge sensor have been described herein, according to some embodiments other types of sensor can be used. Other types of piezoelectric sensors can be used including voltage-transient response and frequency-change response quartz sensors. According to some embodiments, piezoresistive sensor can be used, such as based on metal foil strain, silicon lattice strain, or metallic nanowire strain. Other sensing techniques can also be used such as sensor that make displacement measurements with ultrasonics transducers. Other types of sensor that could be used to measure contact pressure include inductive sensors and optical (opto-electronic) sensors.

Although the discussion above has included the use of one sensor only, according to some embodiments, multiple sensors can be installed on a single BOP. In some examples, the sensors are positioned at different circumferential positions. Multiple sensors spaced apart circumferentially could aid in cases when the drill pipe is potentially eccentrically positioned which might result in misleading measurements by a single sensor. According to some embodiments, the sensor or sensors can be positioned at other positions than shown in FIG. 2. In the design shown in FIG. 2, for example, the sensor(s) can be positioned at locations indicated by dotted arrows A, B or C. The positioning of the sensor(s) should be selected based on a number of factors including the particular design of the BOP. Note that in the case of the BOP shown in FIG. 2, measurements from a sensor mounting the location C might be obstructed by the pusher plate 212 when the BOP is nearly of fully in the closed (compressed) position.

According to some embodiments, one or more sensors can be embedded in the elastomer either by over molding during manufacturing or micromachining path through the material. For further details of embedding sensors in the elastomer material, see US. Pat. Publ. No. 2017/0130562, which is incorporated by reference herein.

According to some embodiments, multiple sensors can be used for redundancy to ensure high reliability of the BOP safety equipment being monitored. The multiple sensors can be: (1) the same type of sensors mounted in similar and/or different locations; and/or (2) different types of sensors mounted in similar and/or different locations. The use of multiple sensors can provide higher measurement quality by cross-correlation and measurement error compensation.

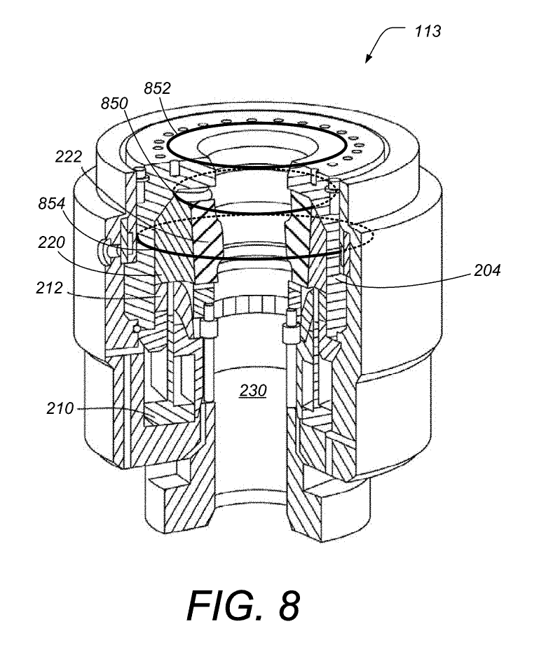

FIG. 8 is a diagram illustrating an annular BOP configured with an elastomer characterization system, according to some further embodiments. In the case of FIG. 8, stress variations in donut 220 of BOP 113 are measured using optical fiber based sensors. Optical fiber 850 is located in contact with donut 220 and is configured with Bragg gratings for distributed Bragg grating measurements. The optical fiber 850, which can be positioned in a groove on the inner surface of casing 204, can be used to detect lengthening of the circumference of donut 220 which can be calibrated to contact pressure (or stress). Other locations can be used to deploy optical fiber based Bragg grating devices due to the high sensitivity of such devices. For example, optical fibers 852 and 854 are shown positioned in contact with the casing 204, but not directly in contact with an elastomer component of BOP 113. Bragg grating measurements can be used to detect minor deformations (elongations) in the circumference of the casing 204, which through calibration can be related to contact pressure or stress values in the elastomer components. According to some embodiments, the fiber Bragg grating measurements can be used to monitor similar quantities as the ones described when using the pressure type and strain type sensors for monitoring elastomers in BOPs including: strain/stress vs. piston position when closing the BOP; strain/stress vs. well pressure when applying wellbore pressure; and strain/stress over time at wellbore pressure plateau.

According to some embodiments, a combination of several sensor technologies is used to enhance measurement robustness for reliability (redundancy) and measurement uncertainty and stability. Combining measurements from two or more types of sensors provides these benefits since the different sensors generally have different calibration errors, drift and performance.

According to some embodiments, any of the sensor(s) used (e.g. pressure, strain, fiber optic, etc.) can be calibrated prior to use. In a laboratory or other controlled setting the sealing pressure of the elastomeric component (i.e. the pressure the component exhorts on a sealing object such as a drill pipe) is measured directly and used to calibrate the readings from the sensor(s). Measures of stress (normal and/or shear), strain (deformation), and pressure from any of the sensors used can be calibrated back to the sealing pressure. Similarly, even though a particular sensor type may be configured measure a particular physical property, the sensor's measurements can be related to and calibrated to monitor sealing pressure of the elastomeric components. For example, a piezoelectric sensor may measure strain (bending) on a membrane, which can be related to stress in direction normal to the surface of the membrane. The sensor can be calibrated using fluid pressure. Although measurement values of the sensor may be expressed in terms of pressure (e.g. psi), the sensor's readings can be related to and calibrated for stress in the normal direction. Other types of sensors and/or positioning can be used (e.g. measuring “shear stress” in a tangential direction), but similarly related back to normal stress and sealing pressure.

According to some embodiments, the measurements and sensor devices described herein can be used to analyze, investigate and in some cases determine likely causes of failure in cases where one or more components of a BOP experience a failure. It has been found that recordings of measurements made of contact pressure and/or other measurements can be used to keep track of various conditions and events that can be related to elastomer lifespan in BOP. Examples of such conditions and events include: the number of BOP actuations (e.g. during fatigue tests and pressure tests), the number of stripping operations performed, and even the number of tool joints that have passed through the BOP during such stripping operations. By looking back at such recordings after a failure has occurred, a better understanding of how and why the failure occurred can results.

According to some embodiments, the techniques described herein can also be applied to other types of BOPs, such as ram type BOPs. In general, the techniques described herein are applicable to any type of BOP where elastomer packers are initially compressed to establish a first contact pressure and then further energized by wellbore pressure to form a sealing surface. While the techniques are applicable to nearly any type of elastomer packers used in BOP applications, they have been found to be especially suitable for annular packers, variable bore ram and flex ram packers, where a larger deformation of the elastomer material is used to establish contact pressure and to form a seal under wellbore pressure. According to some embodiments the elastomer material being monitored undergoes at least 10% of deformation in uniaxial, planar or biaxial mode. According to some other embodiments the elastomer material undergoes at least 20% deformation. In some cases the elastomer material undergoes at least 50% deformation, and in some cases at least 200% deformation.

While the subject disclosure is described through the above embodiments, it will be understood by those of ordinary skill in the art, that modification to and variation of the illustrated embodiments may be made without departing from the concepts herein disclosed.

What is claimed is:

1. A method of monitoring service life characteristics of an elastomer component made of an elastomer material, the elastomer component used for sealing in a BOP comprising:
measuring in situ on the BOP while deployed at wellsite a parameter indicating sealing pressure of the elastomer component; and
estimating a service life characteristic of the elastomer component based at least in part on the in situ measurement of the parameter.

2. A method according to claim 1, wherein the measuring is made with a sensor device that directly contacts elastomer material of the elastomer component being monitored or of a second elastomer component that directly contacts the elastomer component being monitored.

3. A method according to claim 1, wherein the measuring is made with a sensor device configured to measure contact pressure of the elastomer material of the elastomer component being monitored.

4. A method according to claim 3 wherein the sensor device is an integrated electronic piezoelectric (IEPE) pressure sensor.

5. A method according to claim 3 wherein the sensor device is a strain gage configured to measure deformation of a diaphragm contacting the elastomer material.

6. A method according to claim 3 wherein the sensor device includes optical fiber having a plurality of distributed Bragg reflectors contained therein.

7. A method according to claim 6 wherein the optical fiber directly contacts elastomer material of the elastomer component being monitored or of a second elastomer component that directly contacts the elastomer component being monitored.

8. A method according to claim 6 wherein the optical fiber directly contacts a metallic casing that houses the elastomer component being monitored or a second elastomer component that directly contacts the elastomer component being monitored.

9. A method according to claim 1 wherein the estimating is at least based in part on comparing the in situ measuring with a predetermined value or values that indicate when elastomer component is nearing the end of its useful life.

10. The method according to claim 9 wherein the predetermined value or values are set based at least in part on measurements made under real or simulated conditions.

11. The method according to claim 1 wherein the estimating is based at least in part on detecting changes in stress relaxation behavior of the elastomer material.

12. The method according to claim 1 wherein the estimating is based at least in part on physics-based measurements or statistical analysis data processing algorithms.

13. The method according to claim 1 wherein the BOP is an annular type BOP.

14. The method according to claim 1 wherein the BOP is a ram type BOP.

15. The method according to claim 1 wherein the BOP is deployed in a subsea location.

16. The method according to claim 1 wherein the measuring is made with a plurality of types of sensors and the estimating combines data from each of the plurality of types of sensors.

17. The method according to claim 1 wherein during said sealing in the BOP the elastomer material undergoes at least 20% deformation.

18. The method according to claim 17 wherein during said sealing in the BOP the elastomer material undergoes at least 50% deformation.

19. The method according to claim 17 wherein during said sealing in the BOP the elastomer material undergoes at least 200% deformation.

20. A method for investigating causes of failure of one or more components of a BOP comprising:
measuring in situ on the BOP a parameter indicating sealing pressure of an elastomer component used for sealing in the BOP;
recording the in situ measurements; and
analyzing the recoded measurements to determine one or more parameters related to failure of one or more components of the BOP.

21. A method according to claim 21 wherein the one or more parameters includes one or more of the following: number of BOP actuations, number of BOP pressure tests, number of stripping operations preformed using the BOP, and number of joints passing the BOP during stripping operations.
